(19) United States
(12) Patent Application Publication
(10) Pub. No.: US 2020/0066143 A1
(43) Pub. Date: Feb. 27, 2020

(54) A POSITION SELECTING METHOD OF A U-TURN MEDIAN OPENING AT A SIGNALIZED INTERSECTION UNDER THE INFLUENCE OF TRAFFIC FLOW COMPOSITIONS

(71) Applicant: DALIAN UNIVERSITY OF TECHNOLOGY, Dalian, Liaoning (CN)

(72) Inventors: Ronghan YAO, Dalian, Liaoning (CN); Li SUN, Dalian, Liaoning (CN); Wensong ZHANG, Dalian, Liaoning (CN); Liujie ZHENG, Dalian, Liaoning (CN); Meng LONG, Dalian, Liaoning (CN); Yalin LIANG, Dalian, Liaoning (CN)

(21) Appl. No.: 16/340,667

(22) PCT Filed: Nov. 28, 2017
(86) PCT No.: PCT/CN2017/113273

§ 371 Date: Apr. 9, 2019

(30) Foreign Application Priority Data
Oct. 17, 2017 (CN) 201710966270.1

(51) Int. Cl. G08G 1/01; G08G 1/07; G08G 1/095

(52) U.S. Cl. CPC G08G 1/0145; G08G 1/095; G08G 1/0129; G08G 1/07

(57) ABSTRACT

A position selecting method of a U-turn median opening at a signalized intersection under the influence of traffic flow compositions. In the process of determining the traffic capacity of a left-turn lane, different influences of various vehicle arrival modes on the utilization rate of the left-turn green light and the utilization rate of the U-turn green light are analyzed. A method for the traffic capacity of the left-turn lane with the U-turn median opening at a signalized intersection in combination with traffic management demands and traffic flow space-time characteristics is provided, so that the traffic capacity of the left-turn lane under the influence of actual traffic flow compositions is calculated more accurately.

### TECHNICAL FIELD

The present invention belongs to the technical field of traffic management and control, and particularly relates to a position selecting method of a U-turn median opening at a signalized intersection under the influence of traffic flow compositions.

### BACKGROUND

Traffic flow composition refers to the proportion of various types of motor vehicles which run on the actual road. Common types of motor vehicles include car, medium-size vehicle, bus, etc. Vehicle arrival mode refers to the arrival sequence and quantity of various types of vehicles. Effective passing time is obtained by subtracting green light loss time from effective green time.

At present, the research on a U-turn median opening at a signalized intersection mostly aims at standard cars. There is a certain difference between the problem description and the actual traffic operating environment. The conclusions cannot well satisfy the actual traffic demand. In engineering practice, the position selection of the U-turn median opening at an intersection mainly depends on the experience of designers, and is blind. As a result, the left-turning vehicle flow and the U-turning vehicle flow interfere with each other seriously at the intersection, which leads to the waste of the time-space resources of the left-turn lane, even causes the impeded operation of the overall vehicle flow on the approach, and reduces the operating efficiency of traffic flow.

Based on the demands of actual traffic flow compositions, the present invention analyzes the influence of various traffic flow arrival modes on the traffic flow operation law of the left-turn lane, and obtains the green light loss time of the left-turn lane. Then, the present invention establishes a calculation model for the traffic capacity of the left-turn lane, and determines the optimal position of the U-turn median opening with an objective of the maximum traffic capacity, so as to make the left-turn lane have the highest utilization rate of the time-space resources.

### SUMMARY

In view of the defects of the prior techniques, the present invention provides a position selecting method of a U-turn median opening at a signalized intersection under the influence of traffic flow compositions.

The technical solution of the present invention comprises the following steps:

(I) acquiring position selecting background parameters of the intersection with the U-turn median opening

(1) determining geometrical design parameters

for an approach with the U-turn median opening, related geometrical design parameters comprise: the length D_{L} of a left-turn storage bay, the length D_{WS} of the straight line segment of a left-turn waiting area, the length D_{WC} of the curve segment of a left-turn waiting area, the distance D_{S} between the stop lines of the subject approach and its opposite approach, the distance D_{O} between the U-turn median opening and the stop line of the subject approach, and the width D_{U} of the U-turn median opening;

for each approach, related geometrical design parameters comprise: the design speeds V_{L}, V_{T} and V_{R} of a left-turn lane, a through lane and a right-turn lane;

(2) determining a signal control scheme

to ensure the continuity of a U-turning vehicle flow, the left-turning vehicle flow on the approach with the U-turn median opening is released at first, and then the through vehicle flow conflicting with the left-turning vehicle flow is released;

parameters related to a signal timing scheme comprise: a cycle length C, quantity of phases η, a phase number φ={1, 2, 3, . . . , η}, the effective green time for a phase g_{φ} and the inter-green interval G between adjacent phases;

(3) determining time-space characteristics of traffic flow

parameters related to the time-space characteristics of traffic flow comprise: quantity of vehicle types ω̅, a vehicle type number k={1, 2, 3, . . . , ω̅ }, an arrival rate λₖ corresponding to each type of vehicles which arrive on the left-turn lane, a proportion p′ₖ of U-turning vehicles in each type of vehicles, a vehicle length lₖ corresponding to each type of vehicles, the safety spacing l₀ between adjacent vehicles in a stopped queue at an intersection, and the saturation headway h between standard cars;

the above parameters are acquired directly or indirectly;

(II) analyzing the influence of various vehicle arrival modes on the left-turn lane utilization rate

(1) analyzing the influence of various vehicle arrival modes at the beginning of phase 6 on left-turn green light utilization rate

if a U-turning vehicle enters the left-turn lane before some left-turning vehicles and waits for a right-of-way signal at the U-turn median opening before phase 6 starts, a “vacant space” is formed between the U-turn median opening and the last left-turning queueing vehicle in front of the U-turn median opening; subsequent left-turning vehicles must decelerate, stop and queue behind the U-turn median opening; after the left-turn green light starts, subsequent left-turning vehicles initiate behind the U-turn median opening, which reduces the left-turn green light utilization rate; if the “vacant space” is not formed in front of the U-turn median opening before phase 6 starts, then the left-turn lane space is judged to be fully used and the queueing vehicle arrival mode has no influence on the left-turn green light utilization rate during phase 6;

(2) analyzing the influence of various vehicle arrival modes during phase 7 on U-turn green light utilization rate

after phase 7 starts, the left-turning vehicles must decelerate, stop and queue behind the stop line of the left-turn lane and the U-turning vehicles continue to pass through the U-turn median opening; if the left-turning queueing vehicles which arrive in phase 7 at a certain moment just block the U-turn median opening, subsequent U-turning vehicles are forced to decelerate, stop and queue, which results in the empty release of the remaining U-turn green light time in phase 7; if the U-turn median opening is not blocked by the left-turning queueing vehicles before the end of phase 7, the U-turn green light utilization rate in phase 7 is not influenced;

(III) establishing a calculation model for left-turn green light loss time during phase 6

(1) analyzing various arrival modes of left-turning queueing vehicles in front of the U-turn median opening when the “vacant space” is produced in front of the U-turn median opening;

(2) calculating the left-turn green light loss time caused by the blockage of the U-turning vehicles according to the length of the “vacant space”;

(3) calculating the occurrence probability of various arrival modes of left-turning queueing vehicles in front of the U-turn median opening when the “vacant space” is produced in front of the U-turn median opening;

(4) calculating the left-turn green light loss time of phase 6, i.e., a weighted mean value of the left-turn green light loss time influenced by the “vacant space”;

(IV) establishing a calculation model for U-turn green light loss time during phase 7

(1) analyzing various arrival modes of left-turning queueing vehicles when the U-turn median opening is blocked by the left-turning queueing vehicles;

(2) calculating the U-turn green light loss time caused by which the left-turning queueing vehicles block the U-turning vehicles;

(3) calculating the occurrence probability of various arrival modes of left-turning queueing vehicles when the U-turn median opening is blocked by the left-turning queueing vehicles;

(4) calculating the U-turn green light loss time during phase 7, i.e., a weighted mean value of the U-turn green light loss time under the influence of the arrival modes of the left-turning queueing vehicles;

(V) establishing a traffic capacity calculation model for the left-turn lane with the U-turn median opening

(1) in one signal cycle, the effective passing time of phase 6 is obtained by subtracting the left-turn green light loss time of phase 6 from the effective green time of phase 6; and the quantity of standard cars which pass through the left-turn lane during phase 6 is obtained by dividing the effective passing time of phase 6 by the saturation headway between standard cars;

(2) in one signal cycle, the effective passing time of phase 7 is obtained by subtracting the U-turn green light loss time of phase 7 from the effective green light time of phase 7; and the quantity of standard cars which pass through the left-turn lane during phase 7 is obtained by dividing the effective passing time of phase 7 by the saturation headway between standard cars;

(3) the total quantity of the standard cars which pass through the left-turn lane in one signal cycle is obtained by adding the quantities of the standard cars which pass through the left-turn lane during phase 6 and phase 7, then the total quantity is converted into the quantity of the standard cars which pass through the left-turn lane within one hour to obtain the traffic capacity of the left-turn lane under the influence of the position selection of the U-turn median opening;

(VI) determining an optimal position of the U-turn median opening on the left-turn lane

(1) drawing a changing curve between the traffic capacity of the left-turn lane and the position of the U-turn median opening

after the geometrical design parameters of the intersection, the signal control scheme and the traffic flow characteristics are acquired, a value range is determined for the position of the U-turn median opening to obtain the traffic capacities of the left-turn lanes corresponding to the different positions of U-turn median openings, and the changing curve between the traffic capacity of the left-turn lane and the position of the U-turn median opening is drawn;

(2) obtaining the optimal position of the U-turn median opening on the left-turn lane according to the changing curve

according to the changing curve between the traffic capacity of the left-turn lane and the position of the U-turn median opening, the position of the U-turn median opening corresponding to the highest point of the curve is the calculated optimal position of the U-turn median opening.

In the process of determining the traffic capacity of the left-turn lane, the present invention fully considers the difference among the utilization rates of the time-space resources of the left-turn lane under the influence of various vehicle arrival modes, establishes and simplifies the model according to the geometrical design parameters and the actual operation features of the intersection, and determines the optimal position of the U-turn median opening with the objective of the maximum traffic capacity of the left-turn lane, so that the position selection of the U-turn median opening is more reasonable.

The present invention has the following beneficial effects:

(1) When determining the optimal position of the U-turn median opening on the left-turn lane, based on the actual traffic flow composition characteristics and the vehicle flow distribution law at the intersection, the present invention fully considers the difference of the influence of various vehicle arrival modes on the passing of subsequent vehicles during the actual operation process and establishes the corresponding calculation models to ensure that the position selection of the U-turn median opening is more scientific and reasonable;

(2) The present invention continues to use the previous vehicle arrival rate model and the setting form of the U-turn median opening, and firstly creates the position selecting method of the U-turn median opening under the influence of various vehicle arrival modes; the left-turn and U-turn demands of various types of vehicles, the intersection plane design and the signal control scheme are fully considered, so that the established computing formula of the traffic capacity can more accurately describe the influence of traffic flow compositions on the correlation between the traffic capacity of the left-turn lane and the position selection of the U-turn median opening, and the optimal design for urban signalized intersections can be better served.

### DESCRIPTION OF DRAWINGS

FIG. 1 is the schematic diagram of a plane intersection applicable to the present invention.

FIG. 2 is the schematic diagram of a signal phase scheme adopted by the present invention.

FIG. 3 is the schematic diagram of queueing when U-turning vehicles block left-turning vehicles to pass at the beginning of phase 6.

FIG. 4 is the schematic diagram of queueing when left-turning vehicles block U-turning vehicles to pass during phase 7.

FIGS. 5A and 5B are a flow chart of the calculation method of the present invention.

### DETAILED DESCRIPTION

Specific embodiments of the present invention are further described below in combination with the accompanying drawings and the technical solution.

The present invention establishes the calculation model for the traffic capacity of the left-turn lane with the U-turn median opening by analyzing the difference of the influence of various vehicle arrival modes on the passing of subsequent vehicles, and determines the optimal position of the U-turn median opening on the left-turn lane with an objective of the maximum traffic capacity, so as to make the left-turn lane have the highest utilization rate of the time-space resources.

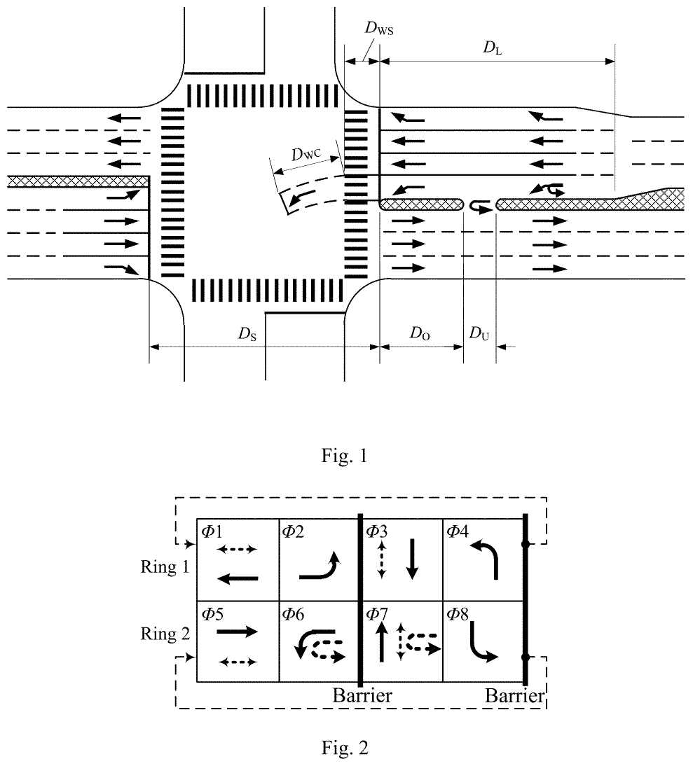

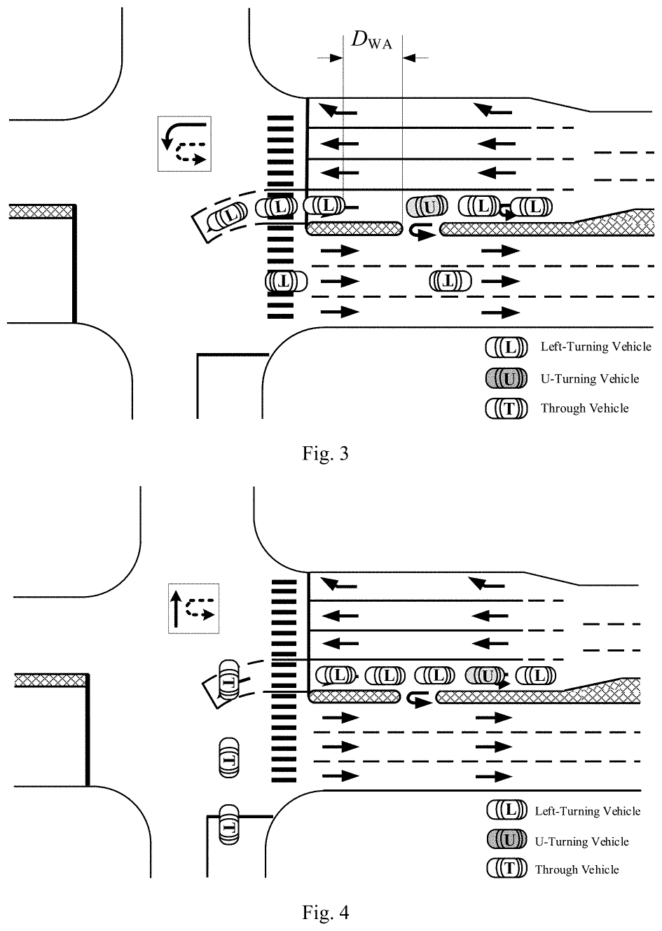

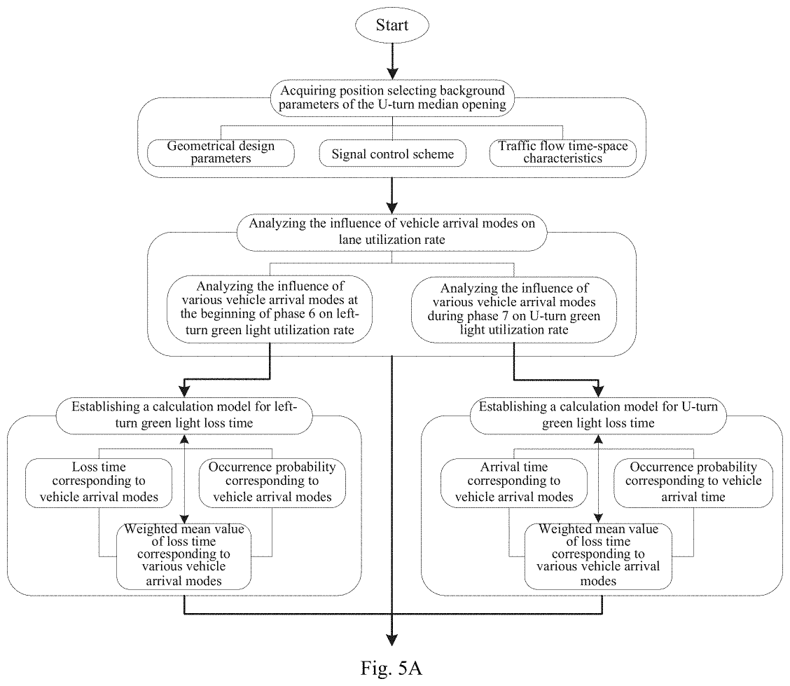

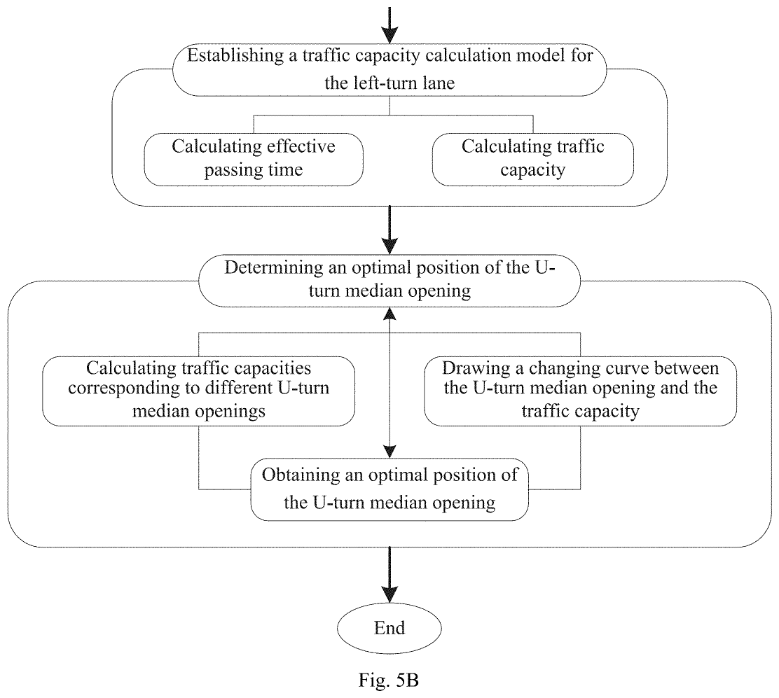

As shown in FIG. 1, FIG. 2, FIG. 3, FIG. 4 and FIGS. 5A and 5B, a position selecting method of a U-turn median opening at a signalized intersection under the influence of traffic flow compositions, comprises the following steps:

(I) acquiring position selecting background parameters of the intersection with the U-turn median opening

(1) determining the geometrical design parameters, as shown in FIG. 1, specifically including: the length D_{L} of a left-turn storage bay of an approach with the U-turn median opening, the length D_{WS} of the straight line segment of a left-turn waiting area, the length D_{WC} of the curve segment of a left-turn waiting area, the distance D_{S} between the stop lines of the subject approach and its opposite approach, the distance D_{O} between the U-turn median opening and the stop line of the subject approach, the width D_{U} of a U-turn median opening, and the corresponding design speeds V_{L} [symbol] V_{T} [symbol] V_{R} of a left-turn lane, a through lane and a right-turn lane on each approach;

(2) determining the signal control scheme, as shown in FIG. 2, wherein phases 1, 3, 5 and 7 respectively control the through vehicle flows on the westbound, southbound, eastbound and northbound approaches; phases 2, 4, 6 and 8 respectively control the left-turning vehicle flows on the eastbound, northbound, westbound and southbound approaches; the control signal of the U-turning vehicle flow starts with phase 6 and closed with phase 7; specific parameters comprise: the cycle length C, the effective green times g₁, g₂, g₃, g₄, g₅, g₆, g₇ and g₈ for all phases, and the inter-green interval G between control phase 5 for the previous through vehicle flow and control phase 6 for the left-turning vehicle flow which also allows U-turning;

(3) determining the time-space characteristics of traffic flow, related parameters comprise: quantity of vehicle types ω̅, a vehicle type number k={1, 2, 3, . . . , ω̅ }), an arrival rate λₖ corresponding to each type of vehicles which arrive on the left-turn lane, a proportion p′ₖ of U-turning vehicles in each type of vehicles, a vehicle length lₖ corresponding to each type of vehicles, the safety spacing l₀ between adjacent vehicles in a stopped queue at an intersection, and the saturation headway h between standard cars;

(II) analyzing the influence of various vehicle arrival modes on the left-turn lane utilization rate

(1) analyzing the influence of various vehicle arrival modes at the beginning of phase 6 on left-turn green light utilization rate

if a U-turning vehicle enters the left-turn lane before some left-turning vehicles and waits for a right-of-way signal at the U-turn median opening before phase 6 starts, a “vacant space” is formed between the U-turn median opening and the last left-turning queueing vehicle in front of the U-turn median opening; subsequent left-turning vehicles must decelerate, stop and queue behind the U-turn median opening; after the left-turn green light starts, subsequent left-turning vehicles initiate behind the U-turn median opening, which reduces the left-turn green light utilization rate; if the “vacant space” is not formed in front of the U-turn median opening before phase 6 starts, then the left-turn lane space is judged to be fully used and the queueing vehicle arrival mode has no influence on the left-turn green light utilization rate in phase 6;

(2) analyzing the influence of various vehicle arrival modes during phase 7 on U-turn green light utilization rate

after phase 7 starts, the left-turning vehicles must decelerate, stop and queue behind the stop line of the left-turn lane and the U-turning vehicles continue to drive through the U-turn median opening; if the left-turning queueing vehicles which arrive in phase 7 at a certain moment just block the U-turn median opening, subsequent U-turning vehicles are forced to decelerate, stop and queue, which results in the empty release of the remaining U-turn green light time in phase 7; if the U-turn median opening is not blocked by the left-turning queueing vehicles before the end of phase 7, the U-turn green light utilization rate in phase 7 is not influenced;

(III) establishing a calculation model for left-turn green light loss time during phase 6

(1) analyzing various arrival modes of left-turning queueing vehicles when the “vacant space” is produced in front of the U-turn median opening

when the “vacant space” exists in front of the U-turn median opening, various arrival modes of the left-turning queueing vehicles are expressed as:

$$\{ \begin{matrix}0 \leq {i}_{k}^{n} \leq int ( \frac{{D}_{WC} + {D}_{WS} + {D}_{O} )}{{I}_{0} + {I}_{k}} ) \\ 0 \leq {\sum }_{k} {i}_{k}^{n} ( {I}_{0} + {I}_{k} ) \leq {D}_{WC} + {D}_{WS} + {D}_{O}\end{matrix} \qquad ( 1 )$$

in the formula: n is the quantity of types of various vehicle arrival modes corresponding to a specified value of D_{O} when phase 6 starts;

k is a vehicle type, and common vehicle types include car, medium-size vehicle, bus, etc.;

iₖⁿ is the quantity of the k th left-turning queueing vehicles corresponding to the n th vehicle arrival mode on the D_{WC}+D_{WS}+D_{O} section when phase 6 starts;

$${\sum }_{k} {i}_{k}^{n}$$

is the total quantity of various types of left-turning queueing vehicles corresponding to the n th vehicle arrival mode on the D_{WC}+D_{WS}+D_{O} section when phase 6 starts;

lₖ is the vehicle length of the k th type of vehicles, m;

l₀ is the average safe spacing between two adjacent vehicles in the stopped queue at the intersection, m;

(2) calculating the waiting time of left-turning vehicles for the departure of U-turning vehicles

during phase 6, the U-turning vehicle must wait for the last through vehicle that passes at the end of the green light of the previous phase to pass through the conflicting point, and then it can initiate and leave the intersection through the U-turn median opening; the time t_{SL} for which the last through vehicle on the opposite approach at the end of the previous phase passes through the U-turn median opening is

$${t}_{SL} = \frac{{D}_{S} + {D}_{O} + {D}_{U}}{{V}_{T}} \qquad ( 2 )$$

in the formula: D_{S} is the distance between the stop lines of the opposite approach and the subject approach, m;

D_{O} is the distance between the U-turn median opening and the stop line of the subject approach, m;

D_{U} is the width of the U-turn median opening, m;

V_{T} is the design speed for the through lane at the intersection, m/s;

it is known that the inter-green interval between phase 5 which controls the previous through vehicle flow and phase 6 is G; it is assumed that the startup loss time of the U-turning vehicle is Δt_{U}; if t_{SL}<G, the through vehicle passes within the inter-green interval between the two phases; at this moment, the waiting time t, of left-turning vehicles for the departure of U-turning vehicles is equal to the startup loss time of the U-turning vehicles, i.e.,

t₁=Δt_{U} (3)

if t_{SL}≥G, the waiting time of the left-turning vehicles for the departure of U-turning vehicles is equal to: the time for which the last through vehicle on the opposite approach at the end of the green light of the previous phase passes through the U-turn median opening subtracted by the inter-green interval, and added by the startup loss time of the U-turning vehicle, i.e.,

$${t}_{1} = \frac{{D}_{S} + {D}_{O} + {D}_{U}}{{V}_{T}} - G + Δ {t}_{U} \qquad ( 4 )$$

in conclusion, the waiting time of left-turning vehicles for the departure of U-turning vehicles is

$${t}_{1} = \{ \begin{matrix}Δ {t}_{U} , & {t}_{SL} < G \\ \frac{{D}_{S} + {D}_{O} + {D}_{U}}{{V}_{T}} - G + Δ {t}_{U} , & {t}_{SL} \geq G\end{matrix} \qquad ( 5 )$$

(3) calculating the time for which the first left-turning queueing vehicle behind the U-turn median opening passes through the “vacant space”

in combination with formula (1), the time t₂ for which the first left-turning queueing vehicle blocked by the U-turning vehicle behind the U-turn median opening passes through the “vacant space” is

$${t}_{2} = \frac{{D}_{WA}}{{V}_{L}} \qquad ( 6 )$$

in the formula: V_{L} is the design speed for the left-turn lane at the intersection, m/s;

D_{WA} is the length of the “vacant space”, and is calculated by the following formula:

$${D}_{WA} = {D}_{WC} + {D}_{WS} + {D}_{O} + {D}_{U} - {\sum }_{k} {i}_{k}^{n} ( {I}_{0} + {I}_{k} ) \qquad ( 7 )$$

in conclusion, the generated loss time t_{UL} (iₖⁿ, D_{O}) for which the left-turning vehicles are blocked by the U-turning vehicles is

t_{UL}(iₖⁿ,D_{O})=t₁+t₂ (8)

(4) calculating the occurrence probability of various arrival modes of left-turning queueing vehicles when the “vacant space” is produced in front of the U-turn median opening

the U-turning vehicles block the left-turning vehicles to pass before the green light of phase 6 starts; it is assumed that the total quantity of various types of left-turning vehicles that

queue on the D_{WC}+D_{WS}+D_{O} section is

$${\sum }_{k} {i}_{k}^{n} ;$$

if at least one U-turning vehicle queues and waits at the U-turn median opening, the occurrence probability P_{UL}(iₖⁿ,D_{O}) of this case is

$${P}_{UL} ( {i}_{k}^{n} , {D}_{O} ) = \frac{( {\sum }_{k} {i}_{k}^{n} ) !}{{\prod }_{k} {i}_{k}^{n} !} \cdot {\prod }_{k} {[ {p}_{k} ( 1 - {p}_{k}^{′} ) ]}^{{i}_{k}^{n}} \cdot {\sum }_{k} {p}_{k} {p}_{k}^{′} \qquad ( 9 )$$

in the formula: Pₖ is the probability that the type of a certain queueing vehicle on the D_{WC}+D_{WS}+D_{O} section is k, and a computational formula of the probability is as follows:

$${p}_{k} = \frac{{λ}_{k}}{{\sum }_{k} {λ}_{k}} \qquad ( 10 )$$

in the formula: λₖ is an arrival rate of various types of vehicles on the left-turn lane of the subject approach;

(5) calculating the left-turn green light loss time during phase 6

when the U-turning vehicles block the left-turning vehicles to pass, a calculation model for the left-turn green light loss time Y_{UL} during phase 6 is

$${Y}_{UL} = {\sum }_{n} {t}_{UL} ( {i}_{k}^{n} , {D}_{O} ) \cdot {P}_{UL} ( {i}_{k}^{n} , {D}_{O} ) \qquad ( 11 )$$

(IV) establishing a calculation model for U-turn green light loss time during phase 7

(1) analyzing various arrival modes of left-turning queueing vehicles when the U-turn median opening is blocked by the left-turning queueing vehicles

it is assumed that the quantity of the queueing vehicles when the left-turning vehicles stop, queue and block the U-turn median opening is

$${\sum }_{k} {j}_{k}^{m} ,$$

and is related to D_{O}, D_{U}, l₀ and the vehicle length lₖ of each arriving left-turning vehicle; at this moment, various arrival modes of the left-turning queueing vehicles are calculated by the following formula:

$$\{ \begin{matrix}{D}_{O} < {\sum }_{k} {j}_{k}^{m} ( {l}_{0} + {l}_{k} ) \leq {D}_{O} + {D}_{U} \\ 0 \leq {j}_{k}^{m} \leq int ( \frac{{D}_{O} + {D}_{U}}{{l}_{0} + {l}_{k}} )\end{matrix} \qquad ( 12 )$$

in the formula: m is the quantity of types of various vehicle arrival modes corresponding to a specified value of D_{O} during phase 7;

jₖ^{m} is the quantity of the k th left-turning queueing vehicles corresponding to the mth vehicle arrival mode on the D_{O}+D_{U} section during phase 7;

(2) calculating the U-turn green light loss time caused by which the left-turning queueing vehicles block the U-turning vehicles

during phase 7, if

$${\sum }_{k} {j}_{k}^{m}$$

left-turning vehicles arrive within g′₇ seconds and just block the U-turn median opening, then subsequent U-turning vehicles cannot pass and are forced to stop, queue and wait; at this moment, the generated loss time t_{LU}(g′₇) for which the U-turning vehicles are blocked by the left-turning vehicles is

t_{LU}(g′₇)=g₇−g′₇ (13)

in the formula: 0<g′₇≤g₇, g₇ is the effective green time for phase 7, s;

(3) calculating the occurrence probability of various arrival modes of left-turning queueing vehicles which block the U-turn median opening

if the arrival of various vehicles on the left-turn lane during phase 7 is random and follows the Poisson distribution, and the proportion of the U-turning vehicles in various arriving vehicles is known, then the quantity Jₖ^{m} of various vehicles corresponding to the arriving

$${\sum }_{k} {j}_{k}^{m}$$

left-turning vehicles is

Jₖ^{m}=jₖ^{m}/(1−p′ₖ) (14)

at this moment, the problem is converted into: the probability P_{LU}(jₖ^{m},D_{O}) for which the total quantity of the arriving vehicles within g′₇ seconds is

$${\sum }_{k} {j}_{k}^{m} , i . e .$$

$${P}_{LU} ( {j}_{k}^{m} , {D}_{O} ) = {\prod }_{k} ( \frac{{( {λ}_{k} {g}_{7}^{′} )}^{{J}_{k}^{m}} {e}^{- {λ}_{k} {g}_{7}^{′}}}{( {J}_{k}^{m} ) !} ) = {\prod }_{k} ( \frac{{( {λ}_{k} {g}_{7}^{′} )}^{[ {j}_{k}^{m} / ( 1 - {p}_{k}^{′} ) ]} {e}^{- {λ}_{k} {g}_{7}^{′}}}{[ {j}_{k}^{m} / ( 1 - {p}_{k}^{′} ) ] !} ) \qquad ( 15 )$$

(4) calculating the U-turn green light loss time during phase 7

when the left-turning vehicles block the U-turning vehicles to pass, a calculation model for the U-turning green light loss time during phase 7 is

$${Y}_{LU} = \frac{1}{m} {\sum }_{m} \frac{{\sum }_{{g}_{7}^{′} = 0}^{{g}_{7}} {P}_{LU} ( {j}_{k}^{m} , {D}_{O} ) \cdot {t}_{LU} ( {g}_{7}^{′} )}{{\sum }_{{g}_{7}^{′} = 0}^{{g}_{7}} {P}_{LU} ( {j}_{k}^{m} , {D}_{O} )} \qquad ( 16 )$$

(V) establishing a traffic capacity calculation model for the left-turn lane with the U-turn median opening

(1) in one signal cycle, the effective passing time of phase 6 is obtained by subtracting the left-turn green light loss time of phase 6 from the effective green time of phase 6; and the quantity of standard cars which pass through the left-turn lane during phase 6 is obtained by dividing the effective passing time of phase 6 by the saturation headway between standard cars;

(2) in one signal cycle, the effective passing time of phase 7 is obtained by subtracting the U-turn green light loss time of phase 7 from the effective green time of phase 7; and the quantity of standard cars which pass through the left-turn lane during phase 7 is obtained by dividing the effective passing time of phase 7 by the saturation headway between standard cars;

(3) the total quantity of the standard cars which pass through the left-turn lane in one signal cycle is obtained by adding the quantities of the standard cars which pass through the left-turn lane during phase 6 and phase 7; then the total quantity is converted into the quantity of the standard cars which pass through the left-turn lane within one hour to obtain the traffic capacity c of the left-turn lane under the influence of the position selection of a U-turn median opening; the traffic capacity calculation model is

$$c = \frac{3600}{C} \cdot ( \frac{{g}_{6} - {Y}_{UL}}{h} + \frac{{g}_{7} - {Y}_{LU}}{h} ) \qquad ( 17 )$$

(VI) determining an optimal position of the U-turn median opening on the left-turn lane

(1) drawing a changing curve between the traffic capacity of the left-turn lane and the position of the U-turn median opening

after the geometrical design parameters of the intersection, the signal control scheme and the traffic flow characteristics are acquired, any integer value within [0,D_{L}−D_{U}] is taken for the position D_{O} of the U-turn median opening to obtain the traffic capacities of the left-turn lanes corresponding to the different positions of U-turn median openings; the changing curve between the traffic capacity of the left-turn lane and the position of the U-turn median opening is drawn;

(2) obtaining the optimal position of the U-turn median opening on the left-turn lane according to the changing curve

according to the changing curve between the traffic capacity of the left-turn lane and the position of the U-turn median opening, the position of the U-turn median opening corresponding to the highest point of the curve is the calculated optimal position of the U-turn median opening.

To sum up, the present invention provides a calculation model for the traffic capacity of the left-turn lane under the influence of traffic flow compositions, solves the position selecting method for the U-turn median opening of the left-turn lane at a signalized intersection under the influence of various vehicle arrival modes, overcomes the blindness of current position selection of the U-turn median opening, enhances the utilization rate of the time-space resources of the intersection and has a higher use value. It should be pointed out that the present invention takes the length of the left-turn storage bay as the value range of the position selection of the U-turn median opening, but is also applicable to the intersection without the left-turn storage bay on the approach, as long as the length of the solid line segment of the approach is used as the value range of the U-turn median opening. For the ordinary technicians in the technical field, some improvements and modifications can be made without departing from the principles of the present invention, and these improvements and modifications should also be considered as the protection scope of the present invention.

1. A position selecting method of a U-turn median opening at a signalized intersection under influence of traffic flow compositions, wherein:
(I) acquiring position selecting background parameters of the intersection with the U-turn median opening
(1) determining geometrical design parameters
for an approach with the U-turn median opening, related geometrical design parameters comprise: a length D_{L} of a left-turn storage bay, a length D_{WS} of a straight line segment of a left-turn pending region, a length D_{WC} of a curve segment of a left-turn pending region, a distance D_{S} between stop lines of the subject approach and its opposite approach, a distance D_{O} between the U-turn median opening and the stop line of the subject approach, and a width D_{U} of the U-turn median opening;
for each approach, related geometrical design parameters comprise: design speeds V_{L}, V_{T} and V_{R} of a left-turn lane, a through lane and a right-turn lane;
(2) determining a signal control scheme
to ensure the continuity of a U-turning vehicle flow, a left-turning vehicle flow on the approach with the U-turn median opening is released at first, and then a through vehicle flow conflicting with the left-turning vehicle flow is released;
parameters related to a signal timing scheme comprise: a cycle length C, quantity of phases η, a phase number φ={1, 2, 3, . . . , r}, a effective green time for a phase g_{φ} and a inter-green interval G between adjacent phases;
(3) determining time-space characteristics of traffic flow
parameters related to the time-space characteristics of traffic flow comprise: quantity of vehicle types ω̅, a vehicle type number k={1, 2, 3, . . . , ω̅}, an arrival rate λₖ corresponding to each type of vehicles which arrive on the left-turn lane, a proportion p′ₖ of U-turning vehicles in each type of vehicles, a vehicle length lₖ corresponding to each type of vehicles, a safety spacing l₀ between adjacent vehicles in a stopped queue at an intersection, and a saturation headway h between standard cars;
(II) analyzing the influence of various vehicle arrival modes on left-turn lane utilization rate
phase 6 controls the left-turning vehicle flow on the approach with the U-turn median opening; phase 7 controls the through vehicle flow conflicting with the left-turning vehicle flow; and the U-turning vehicle flow passes during phase 6 and phase 7;
(1) analyzing the influence of various vehicle arrival modes at the beginning of phase 6 on left-turn green light utilization rate
if a U-turning vehicle enters the left-turn lane before some left-turning vehicles and waits for a right-of-way signal at the U-turn median opening before phase 6 starts, a “vacant space” is formed between the U-turn median opening and the last left-turning queueing vehicle in front of the U-turn median opening; subsequent left-turning vehicles must decelerate, stop and queue behind the U-turn median opening; after a left-turn green light starts, subsequent left-turning vehicles initiate behind the U-turn median opening, which reduces the left-turn green light utilization rate; if the “vacant space” is not formed in front of the U-turn median opening before phase 6 starts, then the left-turn lane space is judged to be fully used and the queueing vehicle arrival mode has no influence on the left-turn green light utilization rate in phase 6;
(2) analyzing the influence of various vehicle arrival modes during phase 7 on U-turn green light utilization rate
after phase 7 starts, the left-turning vehicles must decelerate, stop and queue behind the stop line of the left-turn lane, and the U-turning vehicles continue to pass through the U-turn median opening; if the left-turning queueing vehicles which arrive in phase 7 at a certain moment just block the U-turn median opening, subsequent U-turning vehicles are forced to decelerate, stop and queue, which results in the empty release of the remaining U-turn green time in phase 7; if the U-turn median opening is not blocked by the left-turning queueing vehicles before the end of phase 7, the U-turn green light utilization rate in phase 7 is not influenced;
(III) establishing a calculation model for left-turn green light loss time during phase 6
(1) analyzing various arrival modes of left-turning queueing vehicles when the “vacant space” is produced in front of the U-turn median opening
when the “vacant space” exists in front of the U-turn median opening, various arrival modes of the left-turning queueing vehicles are expressed as:
$$\{ \begin{matrix}0 \leq {i}_{k}^{n} \leq int ( \frac{{D}_{WC} + {D}_{WS} + {D}_{O}}{{l}_{0} + {l}_{k}} ) \\ 0 \leq {\sum }_{k} {i}_{k}^{n} ( {l}_{0} + {l}_{k} ) \leq {D}_{WC} + {D}_{WS} + {D}_{O}\end{matrix} \qquad ( 1 )$$
in the formula: n is the quantity of types of various vehicle arrival modes corresponding to a specified value of D_{O} when phase 6 starts;
k is a vehicle type, and common vehicle types include car, medium-size vehicle, bus, etc.;
iₖⁿ is the quantity of k th left-turning queueing vehicles corresponding to n th vehicle arrival mode on the D_{WC}+D_{WS}+D_{O} section when phase 6 starts;
$${\sum }_{k} {i}_{k}^{n}$$
is the total quantity of various types of left-turning queueing vehicles corresponding to n th vehicle arrival mode on the D_{WC}+D_{WS}+D_{O} section when phase 6 starts;
lₖ is the vehicle length of k th type of vehicles, m;
l₀ is an average safe spacing between two adjacent vehicles in the stopped queue at the intersection, m;
(2) calculating the waiting time of left-turning vehicles for departure of U-turning vehicles
during phase 6, the U-turning vehicle must wait for the last through vehicle that passes at the end of the green light of the previous phase to pass through the conflicting point, and then it can initiate and leave the intersection through the U-turn median opening; the time t_{SL} for which the last through vehicle on the opposite approach at the end of the previous phase passes through the U-turn median opening is
$${t}_{SL} = \frac{{D}_{S} + {D}_{O} + {D}_{U}}{{V}_{T}} \qquad ( 2 )$$
in the formula: D_{S} is a distance between the stop lines of the opposite approach and the subject approach, m;
D_{O} is a distance between the U-turn median opening and the stop line of the subject approach, m;
D_{U} is a width of the U-turn median opening, m;
V_{T} is a design speed for the through lane at the intersection, m/s;
it is known that the inter-green interval between phase 5 which controls the previous through vehicle flow and phase 6 is G; it is assumed that the startup loss time of the U-turning vehicle is Δt_{U}; if t_{SL}<G, the through vehicle passes within the inter-green interval between the two phases; at this moment, the waiting time t₁ of left-turning vehicles for departure of U-turning vehicles is equal to the startup loss time of the U-turning vehicles, i.e.,
t₁=Δt_{U} (3)
if t_{SL}≥G, the waiting time of the left-turning vehicles for departure of U-turning vehicles is equal to: the time for which the last through vehicle on the opposite approach at the end of the green light of the previous phase passes through the U-turn median opening subtracted by the inter-green interval, and added by the startup loss time of the U-turning vehicle, i.e.,
$${t}_{1} = \frac{{D}_{S} + {D}_{O} + {D}_{U}}{{V}_{T}} - G + Δ {t}_{U} \qquad ( 4 )$$
in conclusion, the waiting time of left-turning vehicles for departure of U-turning vehicles is
$${t}_{1} = \{ \begin{matrix}Δ {t}_{U} , & {t}_{SL} < G \\ \frac{{D}_{S} + {D}_{O} + {D}_{U}}{{V}_{T}} - G + Δ {t}_{U} , & {t}_{SL} \geq G\end{matrix} \qquad ( 5 )$$
(3) calculating the time for which the first left-turning queueing vehicle behind the U-turn median opening passes through the “vacant space”
in combination with formula (1), the time t₂ for which the first left-turning queueing vehicle blocked by the U-turning vehicle behind the U-turn median opening passes through the “vacant space” is
$${t}_{2} = \frac{{D}_{WA}}{{V}_{L}} \qquad ( 6 )$$
in the formula: V_{L} is a design speed for the left-turn lane at the intersection, m/s;
D_{WA} is the length of the “vacant space”, and is calculated by the following formula:
$${D}_{WA} = {D}_{WC} + {D}_{WS} + {D}_{O} + {D}_{U} - {\sum }_{k} {i}_{k}^{n} ( {l}_{0} + {l}_{k} ) \qquad ( 7 )$$
in conclusion, the generated loss time t_{UL} (iₖⁿ, D_{O}) for which the left-turning vehicles are blocked by the U-turning vehicles is
t_{UL}(iₖⁿ,D_{O})=t₁+t₂ (8)
(4) calculating the occurrence probability of various arrival modes of left-turning queueing vehicles when the “vacant space” is produced in front of the U-turn median opening
the U-turning vehicles block the left-turning vehicles to pass before the green light of phase 6 starts; it is assumed that the total quantity of various types of left-turning vehicles that queue on the D_{WC}+D_{WS}+D_{O} section is
$${\sum }_{k} {i}_{k}^{n} ;$$
if at least one U-turning vehicle queues and waits at the U-turn median opening, the occurrence probability P_{UL}(iₖⁿ,D_{O}) of this case is
$${P}_{UL} ( {i}_{k}^{n} , {D}_{O} ) = \frac{( {\sum }_{k} {i}_{k}^{n} ) !}{{\prod }_{k} {i}_{k}^{n} !} \cdot {\prod }_{k} [ {{p}_{k} ( 1 - ( {p}_{k}^{′} ) ]}^{{i}_{k}^{n}} \cdot {\sum }_{k} {p}_{k} {p}_{k}^{′} \qquad ( 9 )$$
in the formula: pₖ is the probability that the type of a certain queueing vehicle on the D_{WC}+D_{WS}+D_{O} section is k, and a computational formula of the probability is as follows:
$${p}_{k} = \frac{{λ}_{k}}{{\sum }_{k} {λ}_{k}} \qquad ( 10 )$$
in the formula: λₖ is an arrival rate of various types of vehicles on the left-turn lane of the subject approach;
(5) calculating the left-turn green light loss time during phase 6
when the U-turning vehicles block the left-turning vehicles to pass, a calculation model for the left-turn green light loss time Y_{UL} during phase 6 is
$${Y}_{UL} = {\sum }_{n} {t}_{UL} ( {i}_{k}^{n} , {D}_{O} ) \cdot {P}_{UL} ( {i}_{k}^{n} , {D}_{O} ) \qquad ( 11 )$$
(IV) establishing a calculation model for U-turn green light loss time during phase 7
(1) analyzing various arrival modes of left-turning queueing vehicles when the U-turn median opening is blocked by the left-turning queueing vehicles
it is assumed that the quantity of the queueing vehicles when the left-turning vehicles stop, queue and block the U-turn median opening is
$${\sum }_{k} {j}_{k}^{m} ,$$
and is related to D_{O}, D_{U}, l₀ and the vehicle length lₖ of each arriving left-turning vehicle; at this moment, various arrival modes of the left-turning queueing vehicles are calculated by the following formula:
$$\{ \begin{matrix}{D}_{O} < {\sum }_{k} {j}_{k}^{m} ( {l}_{0} + {l}_{k} ) \leq {D}_{O} + {D}_{U} \\ 0 \leq {j}_{k}^{m} \leq int ( \frac{{D}_{O} + {D}_{U}}{{l}_{0} + {l}_{k}} )\end{matrix} \qquad ( 12 )$$
in the formula: m is the quantity of types of various vehicle arrival modes corresponding to a specified value of D_{O} during phase 7;
jₖ^{m} is the quantity of k th left-turning queueing vehicles corresponding to mth vehicle arrival mode on the D_{O}+D_{U} section during phase 7;
(2) calculating the U-turn green light loss time caused by which the left-turning queueing vehicles block the U-turning vehicles
during phase 7, if
$${\sum }_{k} {j}_{k}^{m}$$
left-turning vehicles arrive within g′₇ seconds and just block the U-turn median opening, then subsequent U-turning vehicles cannot pass and are forced to stop, queue and wait; at this moment, the generated loss time t_{LU}(g′₇) for which the U-turning vehicles are blocked by the left-turning vehicles is
t_{LU}(g′₇)=g₇−g′₇ (13)
in the formula: 0<g′₇≤g₇, g₇ is an effective green time for phase 7, s;
(3) calculating the occurrence probability of various arrival modes of left-turning queueing vehicles which block the U-turn median opening
if the arrival of various vehicles on the left-turn lane during phase 7 is random and follows the Poisson distribution and the proportion of the U-turning vehicles in various arriving vehicles is known, then the quantity Jₖ^{m} of various vehicles corresponding to
$${\sum }_{k} {j}_{k}^{m}$$
left-turning vehicles is
Jₖ^{m}=jₖ^{m}/(1−p′ₖ) (14)
at this moment, the problem is converted into: the probability P_{LU} (jₖ^{m}, D_{O}) for which the total quantity of the arriving vehicles within g′₇ seconds is
$${\sum }_{k} {j}_{k}^{m} , i . e .$$
$${P}_{LU} ( {j}_{k}^{m} , {D}_{O} ) = {\prod }_{k} ( \frac{{( {λ}_{k} {g}_{7}^{′} )}^{{J}_{k}^{m}} {e}^{- {λ}_{k} {g}_{7}^{′}}}{( {J}_{k}^{m} ) !} ) = {\prod }_{k} ( \frac{{( {λ}_{k} {g}_{7}^{′} )}^{[ {j}_{k}^{m} / ( 1 - {p}_{k}^{′} ]} {e}^{- {λ}_{k} {g}_{7}^{′}}}{[ {j}_{k}^{m} \text{/} ( 1 - {p}_{k}^{′} ] !} ) \qquad ( 15 )$$
(4) calculating the U-turn green light loss time during phase 7
when the left-turning vehicles block the U-turning vehicles to pass, a calculation model for the U-turning green light loss time during phase 7 is
$${Y}_{LU} = \frac{1}{m} {\sum }_{m} \frac{{\sum }_{{g}_{7}^{′} = 0}^{{g}_{7}} {P}_{LU} ( {j}_{k}^{m} , {D}_{O} ) \cdot {t}_{LU} ( {g}_{7}^{′} )}{{\sum }_{{g}_{7}^{′} = 0}^{{g}_{7}} {P}_{LU} ( {j}_{k}^{m} , {D}_{O} )} \qquad ( 16 )$$
(V) establishing a traffic capacity calculation model for the left-turn lane with the U-turn median opening
(1) in one signal cycle, the effective passing time of phase 6 is obtained by subtracting the left-turn green light loss time of phase 6 from the effective green time of phase 6; and the quantity of standard cars which pass through the left-turn lane during phase 6 is obtained by dividing the effective passing time of phase 6 by the saturation headway between standard cars;
(2) in one signal cycle, the effective passing time of phase 7 is obtained by subtracting the U-turn green light loss time of phase 7 from the effective green time of phase 7; and the quantity of standard cars which pass through the left-turn lane during phase 7 is obtained by dividing the effective passing time of phase 7 by the saturation headway between standard cars;
(3) the total quantity of the standard cars which pass through the left-turn lane in one signal cycle is obtained by adding the quantities of the standard cars which pass through the left-turn lane during phase 6 and phase 7; then the total quantity is converted into the quantity of the standard cars which pass through the left-turn lane within one hour to obtain the traffic capacity c of the left-turn lane under the influence of a position selection of the U-turn median opening; the traffic capacity calculation model is
$$c = \frac{3600}{C} \cdot ( \frac{{g}_{6} - {Y}_{UL}}{h} + \frac{{g}_{7} - {Y}_{LU}}{h} ) \qquad ( 17 )$$
(VI) determining an optimal position of the U-turn median opening on the left-turn lane
(1) drawing a changing curve between the traffic capacity of the left-turn lane and the position of the U-turn median opening
after the geometrical design parameters of the intersection, the signal control scheme and the traffic flow characteristics are acquired, a value range is determined for the position of the U-turn median opening to obtain the traffic capacities of the left-turn lanes corresponding to the different position of U-turn median openings; the changing curve between the traffic capacity of the left-turn lane and the position of the U-turn median opening is drawn;
(2) obtaining the optimal position of the U-turn median opening on the left-turn lane according to the changing curve
according to the changing curve between the traffic capacity of the left-turn lane and the position of the U-turn median opening, the position of the U-turn median opening corresponding to a highest point of the curve is the calculated optimal position of the U-turn median opening.
